(19) United States
(12) Patent Application Publication
(10) Pub. No.: US 2012/0040307 A1
(43) Pub. Date: Feb. 16, 2012

(54) DENTAL WHITENING DEVICE COMPOSITION

(76) Inventor: Robert T. Postal, Glen Cove, NY (US)

(21) Appl. No.: 12/853,824

(22) Filed: Aug. 10, 2010

(51) Int. Cl. A61C 19/06

(52) U.S. Cl. 433/89

(57) ABSTRACT

A dental whitening device includes a pair of flexible foil sheets of substantially identical structure superimposed over one another and permanently fastened together to define there between an internal region for confining a dental whitening composition and an outlet to the internal region from which to express the dental whitening composition; and an applicator, the applicator includes a pair of arcuately spreadable wings for spreading the dental whitening composition over a surface. The dental whitening composition comprises a hydrogen peroxide source; a carrier exhibiting a viscosity of about 40,000 cps to about 60,000 cps; and, optionally an additive such as thickeners, buffering compounds, chelating agents, surfactants, flavorants and artificial sweeteners.

### TECHNICAL FIELD

This disclosure relates to a dental whitening device and to tooth whitening compositions useful therein.

### BACKGROUND

White teeth have long been considered cosmetically desirable. Unfortunately, due to the presence of chromogenic (color-causing) substances in food, beverages, tobacco, and salivary fluid, in addition to internal sources such as blood, amalgam restoratives, and antibiotics such as tetracycline, teeth become almost invariably discolored in the absence of intervention. The tooth structures that are generally responsible for presenting a stained appearance are enamel, dentin, and the acquired pellicle. Tooth enamel is predominantly formed from inorganic material, mostly in the form of hydroxyapatite crystals, and further contains approximately 5% organic material primarily in the form of collagen. In contrast, dentin is composed of about 20% protein including collagen, the balance consisting of inorganic material, predominantly hydroxyapatite crystals, similar to that found in enamel. The acquired pellicle is a proteinaceous layer on the surface of tooth enamel which reforms rapidly after an intensive tooth cleaning.

Staining of teeth is a result from extrinsic and/or intrinsic staining. Extrinsic staining of the acquired pellicle arises as a result of compounds such as tannins and other polyphenolic compounds which become trapped in and tightly bound to the proteinaceous layer on the surface of teeth. This type of staining can usually be removed by mechanical methods of tooth cleaning. In contrast, intrinsic staining occurs when staining compounds penetrate the enamel and even the dentin, or alternatively arise from sources within the tooth. This type of staining is not amenable to mechanical methods of tooth cleaning and chemical methods, which can penetrate into the tooth structure, are required. Intrinsic tooth staining is generally more intractable and difficult to remove than extrinsic tooth staining.

Consequently, tooth-bleaching compositions generally fall into two categories: (1) gels, pastes, or liquids, including toothpastes that are mechanically agitated at the stained tooth surface in order to affect tooth stain removal through abrasive erosion of stained acquired pellicle; and (2) gels, pastes, or liquids that accomplish the tooth-bleaching effect by a chemical process while in contact with the stained tooth surface for a specified period, after which the formulation is removed. In some cases, an auxiliary chemical process, which may be oxidative or enzymatic, supplements the mechanical process.

Among the chemical strategies available for removing or destroying tooth stains, the most effective compositions contain an oxidizing agent, such as hydrogen peroxide, in order to attack the chromogen molecules in such a way as to render them colorless, water-soluble, or both. In one of the most popular approaches to whitening a patient's teeth, a dental professional will construct a custom made dental bleaching tray for the patient from an impression made of the patient's dentition and prescribe the use of an oxidizing gel to be dispensed into the bleaching tray and worn intermittently for a period of from about 2 weeks to about 6 months, depending upon the severity of tooth staining. These oxidizing compositions, usually packaged in small plastic syringes or tubes, are dispensed directly by the patient into the custom-made tooth-bleaching tray, held in place in the mouth for contact times of greater than about 60 minutes, and sometimes as long as 8 to 12 hours.

Prolonged exposure of teeth to bleaching compositions, as practiced at present, has a number of adverse effects in addition to that of tooth sensitivity. These include: solubilization of calcium from the enamel layer at a pH less than 5.5 with associated demineralization; penetration of the intact enamel and dentin by the bleaching agents, so as to reach the pulp chamber of a vital tooth thereby risking damage to pulpal tissue; and dilution of the bleaching compositions with saliva resulting in leaching from the dental tray and subsequent ingestion.

Alternatively, there are oxidizing compositions (generally those with relatively high concentrations of oxidizers) which are applied directly to the tooth surface of a patient in a dental office setting under the supervision of a dentist or dental hygienist. Theoretically, such tooth whitening strategies have the advantage of yielding faster results and better overall patient satisfaction; however, due to the high concentration of oxidizing agents contained in these so called “in-office” compositions, these oxidizing compositions can be hazardous to the patient and practitioner alike if not handled with care.

Consequently, there exists a need for a dental whitening composition dispensing device that is easy to apply and appropriate for consumer use.

### SUMMARY OF THE INVENTION

In accordance with the present disclosure, a dental whitening composition broadly comprises a hydrogen peroxide source; a carrier exhibiting a viscosity of about 25,000 cps to about 65,000 cps; and, optionally an additive. The hydrogen peroxide source broadly comprises a hydrogen peroxide precursor or a hydrogen peroxide adduct or hydrogen peroxide association complexes. The carrier broadly comprises at least one of the following: glycerin, propylene glycol, and polyethylene glycols, vegetable oil, mineral oils, waxes and esters. The additive broadly comprises at least one of the following: thickeners, buffering compounds, chelating agents, surfactants, flavorants and artificial sweeteners.

The inventive dental whitening device comprises a first flexible planar member that defines a peripheral portion. A second flexible planar member that also defines its own peripheral portion over lies the first flexible planar member. The second flexible planar member is sealed to the first flexible planar member along pouch edge defining portions of the peripheral portions of the first and second flexible planar members. The remaining portions of the peripheral portions of the first and second flexible planar members define an output port. A breakable seal, disposed in sealing relationship with the output port to close the output port, defines an internal compartment on one side of the breakable seal. The first flexible planar member comprises a first applicator portion extending beyond the internal compartment to the other side of the flexible seal. The second flexible planar member comprises a second applicator portion extending beyond the internal compartment to the other side of the flexible seal, the first and second applicator portions having facing surfaces. They liquid permeable member is secured to the facing surfaces of the first and second applicator portions. A dental whitener formula having a viscosity in the range of 25,000 to 65,000 cps is disposed in the pouch between the first and second flexible members. The facing surfaces of the first and second applicator portions are rounded in shape and have a largest dimension greater than the height of a large human tooth.

In one embodiment the dental whitener formula may have a viscosity in the range of about 42,000 cps to about 57,000 cps, although a viscosity in the range of about 48,000 cps to about 52,000 cps is preferred. A viscosity of about 50,000 has been found to produce excellent results. Excellent results should be obtainable using a dental whitener formula which has a viscosity in the range of about 46,000 to about 54,000 cps.

In accordance with the invention of the dental whitening device may incorporate a dental whitener comprising a hydrogen peroxide source, a thickening agent and a carrier such as glycerin.

The hydrogen peroxide source may be a hydrogen peroxide precursor or a hydrogen peroxide adduct or hydrogen peroxide association complexes. In accordance with a preferred environment, the formula may incorporate a hydrogen peroxide source rising at least one of the following: carbamide peroxide, sodium percarbonate, sodium perborate, calcium peroxide, magnesium peroxide, sodium peroxide, and anhydrous poly(vinyl pyrrolidone)/hydrogen peroxide complexes. The hydrogen peroxide source may be present in an amount of about 30 percent to about 40 percent by weight of the total weight of the composition.

The carrier may comprise at least material selected from the group consisting of glycerin, propylene glycol, and polyethylene glycols, vegetable oil, mineral oils, waxes and esters.

The thickener may consist of one or more of the following: carbomer, natural gum, synthetic gum and colloids.

The details of one or more embodiments of the disclosure are set forth in the description below. Other features, objects, and advantages of the invention will be apparent from the description and drawings, and from the claims.

### BRIEF DESCRIPTION OF THE DRAWINGS

FIG. 1 illustrates a pouch for use in applying the dental whitening composition disclosed herein;

FIG. 2 illustrates a side view the pouch of FIG. 1;

FIGS. 3, 4 and 5 illustrate the techniques for operation of the pouch of FIG. 1;

FIG. 6 illustrates another embodiment of the pouch;

FIG. 7 is a section view of the embodiment of FIG. 6;

FIG. 8 illustrates the embodiment of FIG. 6 in side view;

FIG. 9 is a partial perspective view of the embodiment of FIG. 6 ready for operation; and

FIG. 10 illustrates still another embodiment of the pouch in which the dental whitening composition described herein is confined in a shallow sack.

Like reference numbers and designations in the various drawings indicate like elements.

### DETAILED DESCRIPTION

The present disclosure is directed to a composition that whitens the color of teeth when applied to a stained tooth surface. The dental whitening composition disclosed herein may be applied to the stained tooth surface as liquids, gels, pastes, sprays, or as solid delivery systems (for instance, chewing gum or dental floss).

The dental whitening composition may include an active ingredient useful in teeth whitening, for example, a hydrogen peroxide source, and a carrier such as an anhydrous or low-water content, hygroscopic viscous carrier containing glycerin and/or propylene glycol and/or polyethylene glycol.

A prior art formula which comprises 35% carbamide peroxide and further comprises glycerin, a sufficient quantity of flavor, carbomer and EDTA has proven effective in whitening without causing sensitivity problems when used packaged in a syringe that is injected into a bite tray and in whitening pens. In these products, the formula is advanced onto a brush and then painted onto the tooth surface and allowed to dry.

The pouch-type dispenser used in accordance with the invention, when charged with a quantity of prior art whitening materials, has been found lacking, despite the convenience offered by pouch dispensers. In accordance with the invention, a material having the same active chemistry but a thinner viscosity is employed.

The invention may be practiced by using a conventional formula except for reducing the amount of thickener until a formula within the inventive range of viscosity is achieved. The thinner viscosity is useful in addressing problems associated with dispensing prior art materials. In accordance with the invention, the possibility also exists to incorporate other ingredients found in other teeth whiteners, including some whitening toothpastes, for example, remineralizing agents to rebuild enamel. Such agents include calcium peroxide and fluoride. It is believed that hydrogen peroxide destroys tooth chromogens by oxidizing unsaturated carbon-carbon, carbon-oxygen, and carbon-nitrogen bonds found in the stain molecules.

### Hydrogen Peroxide Source

The hydrogen peroxide source may be a hydrogen peroxide precursor or adduct or association complexes such as but not limited to at least one of the following: carbamide peroxide, sodium percarbonate, sodium perborate, calcium peroxide, magnesium peroxide, sodium peroxide, and the anhydrous poly(vinyl pyrrolidone)/hydrogen peroxide complexes, combinations comprising at least one of the foregoing and the like. When contacted by water, carbamide peroxide dissociates into urea and hydrogen peroxide. It is contemplated that any compound which, when in contact with water, is capable of generating, converting to, or otherwise becoming hydrogen peroxide or peroxide anion, will have utility in the formulation of peroxacid. The carbamide peroxide or other hydrogen peroxide precursor, upon placement against the stained tooth surface in the oral cavity, is activated by the aqueous content of the saliva to generate a peroxacid, such as peroxyacetic acid. This activation by saliva generates peroxacid at locations deep within the tooth structure to thereby interact with chromogens that may also be within the tooth structure resulting in enhanced tooth whitening.

Carbamide peroxide may be present in the dental whitening composition disclosed herein in a customary amount of about 35 percent, for example about 22 to about 42 percent by weight of the total weight of the composition, optimally about 22 to about 38 percent by weight of the total weight of the composition, most preferably about 28 to about 35 percent by weight of the total weight of the composition. Alternatively, hydrogen peroxide may be used. 35% carbamide peroxide in the product is roughly equivalent to 12% Hydrogen peroxide in the mouth.

Higher levels of the hydrogen peroxide source may be used in conjunction with a supervised dental whitening procedure in which the soft tissue (i.e., the gingival and other mucosal surfaces) are physically isolated from the teeth being whitened. Hydrogen peroxide concentrations up to about 3 percent are acceptable for short-term (less than 60 minutes) incidental contact with soft tissue.

### Carrier

The inventor has discovered the viscosity of the carrier improves the delivery of the peroxacid. In accordance with the invention, efficacy has been discovered to be a function of the viscosity of the whitening formula. At the same time, viscosity is an important factor in loading of the inventive device with the whitening formula. Existing materials did not easily or well match the delivery device used in accordance with the present invention.

Existing formulas for tooth whitener employ thickening agents with viscosity believed to be in the range of about 80,000 cps, and were found of unsuitable viscosity to match the combined needs of existing filling equipment, and the filling and dispensing characteristics of the pouch delivery system. Removal of the carbomer thickening agent also failed to result in an acceptable product.

Unlike toothpaste which is effective in a wide range of viscosities, the need for the material to adhere to the tooth surface while drying in order for it to work suggested that lowering the viscosity to achieve filling and effective dispensing of the material was likely to be problematic. Nevertheless, it has been found that a gel formula exhibiting a viscosity of about 42,000 cps to about 57,000 cps, preferably about 46,000 cps to about 54,000 cps and most preferably about 48,000 to 52,000 cps works well. A formula viscosity of about 50,000 has been found to produce excellent results.

Carriers should be toxicologically benign and comply with federal regulations set forth by the United States Food and Drug Administration. Suitable carriers may include glycerin, propylene glycol, and polyethylene glycols or an oil-based carrier such as vegetable and mineral oils, and their higher molecular weight counterparts such as waxes and esters. The carrier portion of the dental whitening composition disclosed herein may also include such components as thickeners, buffering compounds, chelating agents, surfactants, flavorants and artificial sweeteners.

### Thickeners

Thickeners are conventionally added to increase viscosity and thus increase contact time of the dental whitening composition on the tooth surface. Suitable thickeners may include organic thickeners such as natural and synthetic gums and colloids include cellulose thickeners such as carboxymethyl cellulose, hydroxyalkyl celluloses such as hydroxypropyl cellulose hydroxyethyl cellulose, gums such as xanthan gum, polyglycols of varying molecular weights sold under the trade name Polyox® and polyethylene glycol. Inorganic thickeners which may be used in the practice of the present invention include amorphous silica compounds such as colloidal silica compounds. Other inorganic thickeners include natural and synthetic clays, lithium magnesium silicate (Laponite) and magnesium aluminum silicate (Veegum). Others thickeners having utility in the formulation of tooth whitening compositions as known to one of ordinary skill in the art may also be included. The amount of thickener, when present, is highly dependent upon the type chosen. Generally, the amount of thickener is selected to achieve the desired viscosity and can easily be determined by adding it to a desired formula until the desired thickness is obtained.

### Buffers

The carrier may also contain a buffer to provide a specific pH for optimal penetration of the dental whitening composition into tooth enamel or to provide for optimal generation of peroxacid. Suitable buffers may include sodium hydroxide, potassium hydroxide, ammonium hydroxide, sodium phosphate di- and tri-basic, potassium phosphate di- and tri-basic, sodium tripolyphosphate, tris(hydroxymethyl)aminomethane, triethanolamine, polyethylenimine, and other alkaline buffers. Within a particular formulation, an alkaline buffer may also serve the purpose of neutralizing carboxylic acid side chains in thickening polymers such as polyacrylic acid and poly(methyl vinyl ether-co-maleic anhydride). Acid buffers, such as citric acid, phosphoric acid, and others may also be used alone or in conjunction with an alkaline buffer to obtain the desirable pH and to provide buffering capacity. The level of buffer of the inventive formula may follow prior art specifications, which like may aspects of whitener formulas are maintained as trade secrets.

### Chelating Agents

The dental whitening composition disclosed herein may optionally contain one or more prior art chelating agent technologies for the purpose of scavenging metal ions in the dental whitening composition during its use. Metals, such as iron, manganese, and copper, and their oxides are known in the art to cause the degradation of hydrogen peroxide through Fenton-type reactions. This particular degradation mechanism is undesirable in that the hydroxyl free radical (OH.) is created and is not as effective as the perhydroxyl anion (HOO⁻) in attacking chromogens. Therefore, it is desirable to encourage the dissociation of the hydrogen peroxide source into perhydroxyl anions, rather than hydroxyl radicals, in order to maximize the effectiveness of the dental whitening composition. It may also be desirable to provide conditions in the inventive compositions which are conducive to the formation of peroxyacetic acid (CH₃COOOH) and its dissociated species, the peroxyacetate anion (CH₃COOO⁻). In a similar fashion as above, the peroxyacetate anion is much more effective as a bleaching or whitening agent than free radical species, such as the peroxyacetyl radical (CH₃COOO.), which form in the presence of metal ions and their oxides.

Although virtually any chelating agent capable of sequestering metal ions in aqueous solution may be employed for the purpose above, particularly useful chelating agents may include the group of phosphonic acids, EDTA, and polyphosphates and other chelating agents known to one of ordinary skill in the art. Phosphonic acids are particularly suitable as chelating agents due to their excellent stability in the presence of peroxides.

### Surfactants

Conventional surface active agents (surfactants) in prior art quantities may be used to lower the surface tension of the dental whitening compositions. Lowering of the surface tension allows for better wetting and spreading of the dental whitening composition on the tooth surface. Some surfactants, such as zwitterionic and fluorinated surfactants have been seen to increase the penetration of the present inventive compositions into the tooth structure. For example, anionic surfactants such as higher alkyl sulfates, e.g., sodium lauryl sulfate, are effective surfactants in oral compositions.

### Flavorants and Artificial Sweeteners

Flavorants may also be included in the dental whitening composition in order to improve palatability and acceptance by the patient or consumer. Flavoring agents may include essential oils as well as various flavoring aldehydes, esters, alcohols, and similar materials. Examples of the essential oils include oils of spearmint, peppermint, wintergreen, sassafras, clove, sage, eucalyptus, marjoram, cinnamon, lemon, lime, grapefruit, and orange. Also useful are such chemicals as menthol, carvone, and anethole. It may be desirable to provide within the dental whitening composition an artificial sweetener such as sodium saccharin and potassium acesulfame. Both flavorants and artificial sweeteners, when present, may each be included in conventional amounts as known to one of ordinary skill in the art.

### Additional Ingredients

Other ingredients may also be added to the dental whitening compositions disclosed herein such as pyrophosphate salts, peroxide stabilizers, and soluble and insoluble calcium compounds. In addition, antimicrobial compounds may also be added to the dental whitening compositions disclosed herein in amounts sufficient to have an antimicrobial effect.

The dental whitening composition disclosed herein may be delivered using any one of a number of methods known to one of ordinary skill in the art. After application to the teeth, the person whose teeth are being whitened should keep his or her mouth open with the lips, cheeks and tongue out of contact with the teeth for about for example one to two minutes after the formula has been applied to the teeth.

In accordance with a particularly preferred embodiment, the pouch of the present invention is an elongated rectangular shape except for a frangible side which is semi-circular in shape. A frangible seal extends across a side leaving a pair of facing semicircular planar flap portions. The other three sides are very securely sealed to each other. This defines the pouch or compartment for receiving the whitening formula. A single sponge extends over entire inside of both flap portions and across the frangible seal. When pressure is applied to the portion of the pouch containing the ingredients, the frangible seal is broken and the formula exits onto the center of the sponge. He semicircular planar flap portions have a diameter approximately 10 to 20% larger than the height of a tooth, effectively providing an applicator whereby the whitener formula may be spread across the buccal surfaces both the upper and lower teeth at the same time. As the user presses, the whitener formula is spread all over the sponge. Generally, a volume of about 0.5 milliliters of the formula has been found to be sufficient when applied to the teeth for about 1 to 2 minutes.

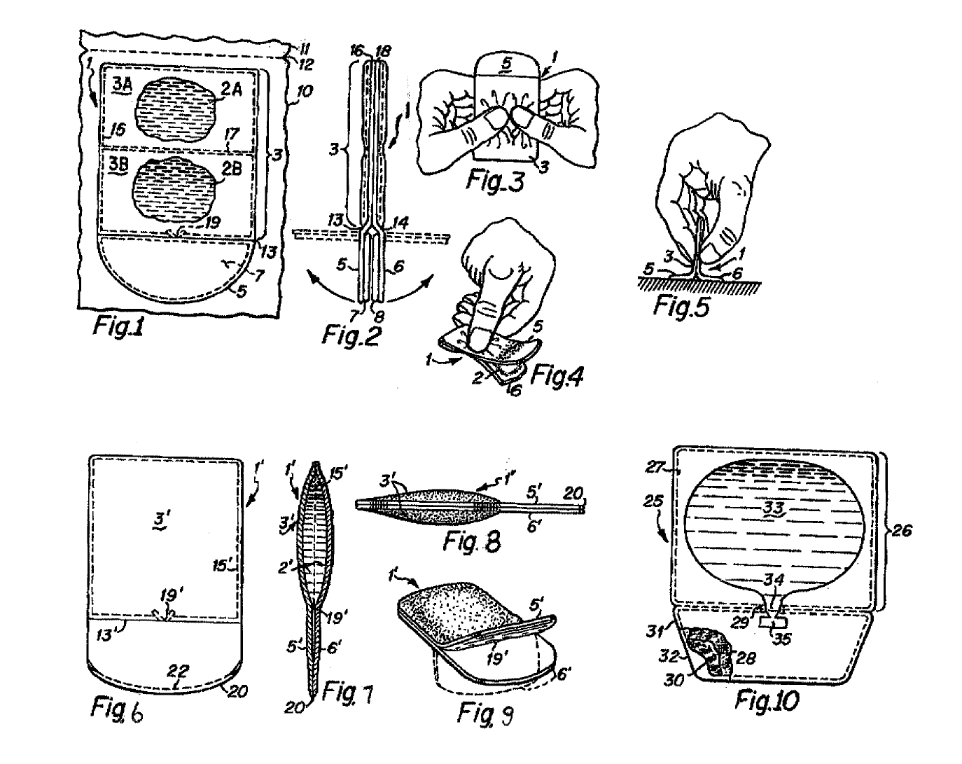

Reference is made to FIG. 1 illustrating a prior art pouch 1, useful for applying the whitening composition of the present invention, packaged in a sealed wrapper 10. As illustrated pouch 1 contains a container section 3, represented by a generally rectangular portion. Container section 3 is divided into two separate compartments 3A and 3B, illustrated as being filled with ingredients 2A and 2B, respectively, e.g., the dental whitening composition described herein or a combination of ingredients that upon mixing formulate the dental whitening composition. A wing or flap 5 is integrally formed at the narrow end of container section 3. Flap 5 is semi-circular in shape and contains no sharp corners that might catch on a surface. A fold line 13 is included between flap 5 and container section 3.

A thin absorbent layer or a pad 7, outlined in dash lines, is attached to the underside surface of flap 5. Pad 7 may be a soft cotton material of the kind employed in, for example, a Band Aid® brand adhesive bandages, commercially available from Johnson & Johnson, which is both absorbent and soft, or pad 7 may be constructed of felt or like material.

The opposite or rear side of pouch 1 is a mirror image of the top side, substantially identical in structure, except that the corresponding pad 7 is located on the upper surface of flap 5. Referring now to FIG. 2, pouch 1 is illustrated in a not-to-scale side view. The construction of pouch 1 is substantially symmetrical through the center. As illustrated in FIG. 2, container section 3 is formed between a front wall panel 16 and a rear wall panel 18 that are joined together along their respective edges. As may not be evident from FIG. 2, unfilled, pouch 1 would appear flat in side view. However, because pouch 1 is illustrated as filled with ingredients 2A and 2B consistent with FIG. 1, pouch 1 expands in thickness. Due to the confined ingredients 2A and 2B, front and rear wall panels 16 and 18, and the sides of pouch 1, bulge out sideways.

One of ordinary skill in the art will recognize pouch 1 is relatively thin, its thickness being quite small relative to its length and width. That small thickness provides essentially a relatively flat shape to pouch 1. Such a shape permits large quantities of pouch 1 to be stacked and packaged in a box.

As shown in FIG. 2, a second flap 6 is located underlying flap 5. A fold line 14 is located between second flap 6 and container section 3. Second flap 6 also includes an absorbent pad 8 of like construction to pad 7, which pad 8 confronts.

Container section 3 and flaps 5 and 6 in this embodiment are suitably formed from two webs or, as variously termed, sheets of flexible packaging foil material that are heat sealed together. Flaps 5 and 6 are formed of an end portion of such sheets that have not been thermo-sealed together. The end portions of each sheet are disconnected in use so they may spread apart during use, as represented by the phantom lines in FIG. 2. As later herein described, flaps 5 and 6 may be temporarily joined by a tear-off strip to prevent the flaps from spreading apart prior to use, maintaining a relatively flat shape for convenient packing of multiple units of pouch 1 in a larger box.

Referring again to FIG. 1, the two sheets or panels of packaging material of container section 3 and flaps 5 and 6 are bonded together by heat sealing the thermoplastic material along the outer edge or periphery of container portion 3 to form a relatively shallow compartment area. The heat sealing produces a seal or a thermal seam 15, represented by a dash line. A compartment divider seal 17, illustrated by double dash lines, extends across opposite portions of thermal seam 15, thus dividing container section 3 into separate compartments, and an outlet seal passage 19 to close the compartment's outlet are also thermally formed.

Thermal seam 15 is quite strong, liquid tight and resists cracking or breaking even under extreme pressures. Thermal seal 15 cannot be broken in ordinary use even if pressed by hand against a hard surface. Furthermore, thermal seal 15 cannot be broken even by pulling flaps 5 and 6 apart with excessive force. One of ordinary skill in the art that have used flat packages for dispensing mustard and other condiments should be familiar with the strength of the bond. The foregoing thermal seam extends almost entirely around the periphery of the container section 3, leaving the outlet seal passage 19 at the center of the lower end in FIG. 1. The passage is the outlet to the container. The width of that outlet seal passage 19 is less than the width of the container section 3, typically a fraction of the container's width, such as no greater than one-half that width, although the exact width chosen for any practical embodiment of pouch 1 may depend on the physical characteristics of the spreadable dental whitening composition described herein.

The small passage in thermal seam 15 is closed by outlet seal 19, a conventional frangible seal that appears in the shape of a chevron in FIG. 1. Unlike thermal seam 15, which is almost impossible to break by hand, exit seal 19 may be easily broken. The inter-compartment seal 17 is not quite as strong as exit seal 19, as it is necessary to break inter-compartment seal 17 first in order to allow two ingredients 2A and 2B to mix before dispensing a mixture of ingredients 2A and 2B.

Reference is again made to FIG. 1. To ensure sterility and/or as an additional safeguard against unintended or accidental leakage and/or to preclude the flaps 5 and 6 from spreading apart prior to use, pouch 1 is sealed within a plastic or Cellophane® wrapper 10, which forms a relatively flat, shallow bag. Wrapper 10 includes a tear-off strip end 11, formed by spaced cuts there through and along a dash line 12. Apart from its use in the described combination, plastic wrappers of the foregoing type and the use thereof in automatic packaging machinery are well known in the packaging art by one of ordinary skill in the art and need not be described further. When ready to use the packaged dental whitening composition described herein, the tear strip is removed and pouch 1 is withdrawn from the wrapper.

The principal body of pouch 1 is formed of familiar packaging flexible metal foil material, typically a laminate of metal foil and plastic, as later herein discussed in greater detail. The front and rear wall panels 16 and 18 are thin and flexible and may be easily temporarily deformed when filled with fluid by squeezing the sides of container section 3 between one's finger and thumb.

For use, removed from wrapper 10, squeezing the sides of pouch 1 between the thumb and forefinger of each hand, as represented in FIG. 3, temporarily deforms the flexible front and rear wall panels 16 and 18 while also applies sufficient pressure on the confined ingredients 2A and 2B to cause the same to fracture inter-compartment divider seal 17, and permit the ingredients 2A and 2B to mix. By squeezing or kneading the sides of the package further, the ingredients may be thoroughly mixed. Should either front or rear wall panel 16 or 18 of container section 3 be transparent, one might include coloring material in the ingredients 2A or 2B to provide a visual indication through the sides of pouch 1 of the completeness of their mixture.

Following such mixing, squeezing the package with greater force should force the confined ingredients 2A and 2B to burst open outlet seal passage 19 and permit the contents to be expressed from pouch 1, such as partially represented in FIG. 4. Suitably, by squeezing the sides of pouch 1 between one's thumb and fingers to flex front and rear wall panels together reduces the size of the internal cavity and subjects the contents to a high enough pressure sufficient to cause the confined ingredients 2A and 2B to burst or otherwise break outlet seal passage 19, which thereby opens the pouch's dispensing outlet.

The dispensed mixture of ingredients 2A and 2B cause the flaps 5 and 6 to pivot in opposite directions spreading them somewhat apart. Holding the container section 3 with ones fingers, the user may then press the mixture against the desired surface, spreading the flaps 5 and 6 further apart and applying the mixture to the surface, such as represented in FIG. 5. As shown, the length of the flaps 5 and 6 and their width is great enough to service this applicator function. The user may then move the spread flaps 5 and 6 back and forth and/or up and down along the surface, spreading the dispensed mixture about the surface.

As those skilled in the art appreciate, the invention may be produced using existing flexible packaging materials and assembly processes for the most part. It should be appreciated that the foregoing embodiment can be fabricated by hand, given the materials and a hand held heat bar, such as a hot iron. However, automated machine assembly is preferred for high volume manufacture.

Reference is made to FIG. 6 which illustrates a second embodiment of the pouch. For convenience, the same number used to identify elements of the prior embodiment is used for like elements appearing in this embodiment, but with those numbers primed. In this, pouch 1′ contains only a single compartment 3′. Like the embodiment of FIG. 1, pouch 1′ is formed of two substantially identical sheets of plasticized metal foil laminate superimposed over one another and joined together by thermal seams. Applied by standard thermo seal technique, thermal seam 15′, extends about the compartment section 3′, interrupted in that path by a thermal seal, chevron seal 19′, a frangible closure or seal, as variously termed, located at a midpoint of one end of the pouch 1′. The chevron seal 19′ closes the opening in thermal seam 15′ that serves as the dispensing outlet. Thermal seam 15′ extends from the rear end of the pouch 1′ and extends along the side for about eighty percent of the length of the pouch 1′ and then turns in direction, leaving the remaining end portion of the foil laminate's length unsealed and free to flap.

The pouch 1′ contains a fold line 13′ formed in the sheet material, and a like fold line on the other sheet, not visible in this view. The fold lines assist the flaps 5′ and 6′ to more easily swung around. However, as in the prior embodiment, in alternative embodiments of the invention the fold line may be omitted if desired. Generally speaking, where the material selected is sufficiently pliant, it is possible to pivot or arcuately spread apart the flaps 5′ and 6′ over a wide arc without the inclusion and assistance of a fold line. The inclusion of a fold line is desirable when the ingredients exhibit a larger viscosity such as the dental whitening composition described herein.

To demonstrate the versatility of the invention, the foregoing embodiment does not include the absorbent pads used in the embodiment of FIG. 1, such as absorbent pads 7 and 8 in that prior figure. The outer end of the two flaps 5′ and 6′ in this embodiment, flap 5′ and the underlying flap 6′ visible in FIG. 7, are held together by a tear seal strip 20. The tear strip retains the flaps in place, essentially extending straight and in parallel, for more convenient packaging of such pouches 1′, as filled with product, in multiple quantities in a box. Tear seal strip 20 is formed integrally in the sheet material at the end of the flaps 5′ and 6′, by adhesively or thermally joining a narrow edge portion of the flap ends together and incorporating a familiar tear line 22 in the end of the flaps. The user simply tears off tear seal strip 20 to disconnect the flaps 5′ and 6′ from one another, which permits the flaps 5′ and 6′ to pivot about their respective fold lines independently of one another.

FIG. 7 illustrates the embodiment of FIG. 6 in section view. Flaps 5′ and 6′ extend essentially in parallel, but are connected together at the distal end by tear off tab 20. The proximal end of each flap 5′ and 6′ is integral with the end of container section 3′. Thermal seam 15′, that extends about the periphery of the container section 3′ connecting together the edges of the front and back panels and defines the container's internal cavity, is partially visible in the figure. The container section is illustrated as filled with an ingredient 2′ such as the dental whitening composition described herein.

As illustrated in side view in FIG. 8, the sides of the container section 3′ bulge outwardly, since the pouch 1′ is illustrated as filled with the dental whitening composition described herein. With the tear off tab 20 removed, flaps 5′ and 6′ can be manually spread apart as illustrated in partial perspective in FIG. 9. The frangible chevron seal 19′, which closes the passage into the container section 3′, is indicated as being centrally positioned. As indicated by the dash line, flap 6′ may pivot downwardly even further, should the packaging material used have a greater degree of pliancy or flexibility.

Chevron seal 19′ may be fractured by pressing the sides of the package together, to burst the seal 19′ and express the dental whitening composition through the open outlet. Alternatively, with a slight change in positioning of the chevron seal, the chevron outlet seal may be broken, torn apart, when the flaps 5′ and 6′ are manually spread apart. By having chevron seal 19′ extend a small amount into the region occupied by the flaps 5′ and 6′, a front portion of the chevron seal 19′ is then thermally formed between the two flaps 5′ and 6′. As that chevron seal 19′ is relatively weak, intentionally made frangible, when the flaps 5′ and 6′ are pulled apart, that pulling force detaches that portion of the chevron seal 19′, thereby opening the outlet. As earlier noted, although the flaps 5′ and 6′ are pulled apart, the package remains intact since it is not reasonably possible to tear the package apart by using excess pull on the flaps 5′ and 6′ due to the strength of the thermal seams.

At first glance the foregoing alternative appears superficially similar to the “tear apart” package used for packaging adhesive bandages, such as those marketed by the Johnson & Johnson Company. As one recalls, such a bandage package is formed between two strips of a generally moisture resistant or impervious paper composition that are joined together in overlying relationship to form a bandage compartment and two flaps, the flaps extending from an end and serving as “pull apart” tabs to the package. By pulling the tabs apart, the two strips are separated, tearing the package apart, to readily allow full access to the adhesive bandage. Other than to note some similarities allowed by hindsight, from the preceding description one easily recognizes that the pouch 1′ differs in structure, purpose and function.

Although the container outlet passage and the chevron seal 19′ to the container section 3′ are centrally positioned in this embodiment, those skilled in the art appreciate that those elements may alternatively be positioned at other less preferred locations along the pouch's end, without departing from the scope of the pouch. The illustrated positioning ensures that there is less likelihood that the dispensed dental whitening composition will in small part fall off a side edge of the flap 5′ or 6′.

Further, it is appreciated that the axis of the outlet passage in the foregoing and in the succeeding embodiments is preferably straight and coaxial with the principal axis of the container. In that way when the dental whitening composition is expressed under pressure from the container, the flow of the dental whitening composition should predominantly be toward the front of the pouch. However, as those skilled in the art appreciate, the passage axis may be oriented in other directions in alternate embodiments without departing from the scope of the pouch, as example, should one prefer the dental whitening composition flow to be toward one side or other of the flap.

Reference is next made to FIG. 10, which illustrates still another embodiment of the pouch. Like the single compartment embodiment of FIG. 6, a pouch 25 is formed of two substantially identical sheets of plasticized metal foil laminate superimposed over one another and joined together by thermal seams. Applied by standard thermo seal technique, thermal seam 27 extends about the compartment section 26 of the pouch 25, interrupted in that path by a small outlet or passage 29, located at a midpoint of one end of the pouch 25. Thermal seam 27 extends from the rear end of the unit and extends along side for about eighty percent of the length of the pouch 25, leaving the remaining end portion unsealed and free to flap, defining, as in the case of the prior embodiments, an upper flap 31, and a lower flap 32, only partially visible in this figure in the cut- out section to the lower left, underlying flap 31.

Each flap 31 and 32 includes an absorbent pad 28 and 30, respectively, the latter pad being partially illustrated in the partial cut-out section to the lower left. Pads 28 and 30 are attached to the inside surface of the flaps 31 and 32, as in the embodiment of FIG. 1, so that the pads 28 and 30 face one another. Alternatively, one of ordinary skill in the art will appreciate that a single larger pad containing a central aperture may be substituted for the two pads 28 and 30.

A relatively shallow sac or bladder or bag 33 is located within compartment section 26's internal region defined between the two foil laminate sheets. Bag 33 is formed in the same manner as the other portion of the unit, that is, by heat sealing the peripheral edge together to form a closed compartment. Further, the bag is filled with the dental whitening composition prior to heat sealing the outer sheets together. Bag 33 contains a small neck 34, which serves as the outlet. The small neck 34 extends through passage 29 and protrudes into the region of the confronting flaps 31 and 32. The small neck 34 is closed at the end by a frangible seal, particularly a tear tab 35.

In this embodiment, although the two sheets of flexible foil material are fused together to define an internal compartment, that compartment need not be liquid tight. The internal compartment subsumes another container, which is liquid tight, to contain the dental whitening composition.

For use, the user spreads the confronting flaps 31 and 32 aside and accesses and removes the tear tab 34, opening the sack 33. Then, pressing the sides of the container with the fingers (as in FIG. 4), the liquid polish is expressed from the sack 33 onto the pads 28 and 30, spreading the respective associated flaps 31 and 32 apart. The user then grips the sides of the pouch 25 and applies the dental whitening composition to a tooth and spreads the composition about the tooth's surface with the spread out pads.

One or more embodiments of the present invention have been described. Nevertheless, it will be understood that various modifications may be made without departing from the spirit and scope of the invention. Accordingly, other embodiments are within the scope of the following claims.

1. A dental whitening composition in a dispenser pouch, comprising:
a container, said container having top and bottom surfaces and first and second ends;
said top and bottom surfaces having a length and width dimension defining a surface area sufficient in size to be gripped by at least the thumb of a hand, whereby said container may be gripped between the thumb and another finger of said hand;
said container including a dispensing outlet located at said second end;
a dental whitening composition;
said container defining a cavity for holding said dental whitening composition; and
an applicator, said applicator being integrally attached to said container to define therewith a unitary one-piece structure;
said applicator comprising:
first and second flaps, each of said flaps being integrally attached to and extending outwardly from said second end of said container and being capable of being spread apart pivotally in opposite directions over a wide arc;
said first flap being located to one side of said dispensing outlet and said second flap being located to an opposite side of said dispensing outlet; and
said first flap defining an applicator surface on an underside surface thereof and said second flap defining an applicator surface on an upperside surface thereof,
said dental whitening composition comprising a whitener in a formula exhibiting a viscosity of about 40,000 cps to about 60,000 cps.

2. A dental whitening composition in a dispenser pouch as in claim 1, wherein said length and width dimension being substantially greater than the thickness dimension between said top and bottom surfaces to define a relatively thin appearance.

3. A dental whitening device, comprising:
(a) a first flexible planar member, said first planar member defining a peripheral portion;
(b) a second flexible planar member, said second planar member defining a peripheral portion, said second flexible planar member overlying said first flexible planar member, and said second flexible planar member being sealed to said first flexible planar member along a pouch edge defining a portion of the peripheral portions of said first and second flexible planar members, the remaining portions of said peripheral portions of said first and second flexible planar members defining an output port;
(c) a breakable seal, disposed in sealing relationship with said output port to close said output port, to define an internal compartment on one side of said breakable seal;
(d) said first flexible planar member comprising a first applicator portion extending beyond said internal compartment to the other side of said flexible seal;
(e) said second flexible planar member comprising a second applicator portion extending beyond said internal compartment to the other side of said flexible seal, said first and second applicator portions having facing surfaces;
(f) a liquid permeable member secured to said facing surfaces of said first and second applicator portions; and
(g) a dental whitener formula having a viscosity in the range of 25,000 to 65,000 cps disposed in the pouch between said first and second flexible members.

4. A device as in claim 3, wherein said dental whitener formula has a viscosity in the range of about 42,000 cps to about 57,000 cps.

5. A device as in claim 3, wherein said dental whitener formula has a viscosity in the range of about 48,000 cps to about 52,000 cps, and said liquid permeable member is an open cell foam plastic sponge.

6. A device as in claim 3, wherein said dental whitener formula has a viscosity of about 50,000 has been found to produce excellent results.

7. A device as in claim 3, wherein said dental whitener formula has a viscosity in the range of about 46,000 to about 54,000 cps, and wherein said liquid permeable member is an open cell foam plastic sponge overlying a frangible member.

8. A dental whitening device as in claim 7, wherein said dental whitener formula comprises:
a hydrogen peroxide source;
a thickening agent; and
a carrier.

9. The dental whitening device of claim 8, wherein said hydrogen peroxide source comprises a hydrogen peroxide precursor or a hydrogen peroxide adduct or hydrogen peroxide association complexes.

10. The dental whitening device of claim 8, wherein said hydrogen peroxide source comprises at least one of the following: carbamide peroxide, sodium percarbonate, sodium perborate, calcium peroxide, magnesium peroxide, sodium peroxide, and anhydrous poly(vinyl pyrrolidone)/hydrogen peroxide complexes.

11. The dental whitening device of claim 8, wherein said hydrogen peroxide source is present in an amount of about 30 percent to about 40 percent by weight of the total weight of the composition.

12. The dental whitening device of claim 8, wherein said carrier comprises at least one of the following: glycerin, propylene glycol, and polyethylene glycols, vegetable oil, mineral oils, waxes and esters.

13. The dental whitening device of claim 12, wherein said thickener comprises carbomer, natural gum, synthetic gum and colloids.

14. A dental whitening composition dispenser pouch, comprising:
a pair of flexible sheets, said flexible sheets being connected together to define therebetween a cavity region for confining a dental whitening composition and an applicator, said applicator comprising a pair of end flaps, one of said flaps integrally formed in an end of one of said flexible sheets in said pair and the other of said flaps being integrally formed in the corresponding end of the other one of said flexible sheets in said pair, and said flaps being positioned in overlying relationship; and a frangible closure integrally formed between said pair of sheets, said closure being normally closed and providing, when open, a passage from said cavity region to said flaps through which said spreadable substance may be expressed into at least the region between said flaps, whereby sufficient finger pressure exerted to press said flexible sheets toward one another increases pressure on said confined spreadable substance sufficient to express said spreadable substance from said cavity region through said passage and into contact with said flaps, said dental whitening composition comprising a hydrogen peroxide source; a carrier exhibiting a viscosity of about 40,000 cps to about 60,000 cps.

15. A device as in claim 3 wherein said facing surfaces of said first and second applicator portions are rounded in shape and have a largest dimension greater than the height of a large human tooth.
